(19) United States
(12) Patent Application Publication
(10) Pub. No.: US 2020/0160733 A1
(43) Pub. Date: May 21, 2020

(54) AUTONOMOUS AERIAL VEHICLE NAVIGATION SYSTEMS AND METHODS

(71) Applicant: ENSCO, INC., Springfield, VA (US)

(72) Inventors: Matthew Dick, Charlottesville, VA (US); Tarek Shalaby, Alexandria, VA (US); Amaury Rolin, Charlottesville, VA (US); Andrew Straatvelt, Fairfax, VA (US); Sajjad Meymand, McLean, VA (US); Jeffrey Bloom, Silver Spring, MD (US); Anthony Kim, Fairfax, VA (US); Humberto Fernandez, Annandale, VA (US); Zhipeng Liu, Great Falls, VA (US); Samson Yilma, Arlington, VA (US); Xin Chen, Rockville, MD (US)

(21) Appl. No.: 16/684,194

(22) Filed: Nov. 14, 2019

Related U.S. Application Data
(60) Provisional application No. 62/768,598, filed on Nov. 16, 2018.

(51) Int. Cl. G08G 5/00; B64C 39/02; G06K 9/00; B61L 23/04

(52) U.S. Cl. CPC G08G 5/0069; B64C 39/024; G06K 9/0063; B64C 2201/127; B64C 2201/145; B64C 2201/123; B61L 23/041

(57) ABSTRACT

A method for autonomously navigating an aerial vehicle along a railroad track includes obtaining, from one or more cameras coupled to the aerial vehicle, image data reproducible as an image of a portion of the railroad track, identifying, based at least in part on the image data, a first rail and a second rail of the portion of the railroad track, determining, based at least in part on the identified first and second rails of the portion of the railroad track, a centerline of the portion of the railroad track, and generating, based at least in part on the determined centerline, flight instructions to cause the aerial vehicle to move relative to the railroad track.

### CROSS-REFERENCE TO RELATED APPLICATIONS

This application claims the benefit of and priority to U.S. Provisional Application No. 62/768,598, filed on Nov. 16, 2018, which is hereby incorporated by reference herein in its entirety.

### TECHNICAL FIELD

The present disclosure relates generally to autonomous aerial vehicle navigation systems and methods, and more particularly, to systems and methods for autonomously navigating an aerial vehicle along a railroad track.

### BACKGROUND

Unmanned aerial vehicles (“UAVs”) are useful in a variety of applications. Generally, unmanned aerial vehicles can be navigated to a desired destination using one of two methods. First, the aerial vehicle can be manually controlled by a user (e.g., using a remote control). However, this method requires the user to be specially trained in the operation of the aerial vehicle, and also requires the user to continually monitor and control the flight path of the aerial vehicle throughout its entire flight. In some cases, the user may also need to be physically located within a certain proximity to the aerial vehicle during operation. Second, the aerial vehicle can be navigated autonomously by preprogramming a specific flight path for the aerial vehicle to follow to reach its destination. Preprogramming the flight path is often time consuming and requires reference waypoints and/or landmarks to control the flight path, which in turn requires knowledge of the surrounding terrain (e.g., to choose reference waypoints, program the aerial vehicle to avoid potential obstacles, etc.). The present disclosure is directed to solving these and other problems.

### SUMMARY

According to some implementations of the present disclosure, a method for autonomously navigating an aerial vehicle along a railroad track, the method comprising obtaining, from one or more cameras coupled to the aerial vehicle, image data reproducible as an image of a portion of the railroad track, identifying, based at least in part on the image data, a first rail and a second rail of the portion of the railroad track, determining, based at least in part on the identified first and second rails of the portion of the railroad track, a centerline of the portion of the railroad track, and generating, based at least in part on the determined centerline, flight instructions to cause the aerial vehicle to move relative to the railroad track

According to some implementations of the present disclosure, a method for an aerial vehicle to navigate along a railroad track comprising initializing, using a flight controller, movement of the aerial vehicle from an initial position to a predetermined altitude, obtaining, from one or more cameras coupled to the aerial vehicle, image data reproducible as an image of a portion of the railroad track, identifying, based at least in part on the image data, a portion of a first rail of the railroad track, the portion of the first rail defining a path, and based at least in part on the path, generating flight instructions for the aerial vehicle.

According to some implementations of the present disclosure, a method for autonomously navigating an aerial vehicle along a railroad track, the method comprising with the aerial vehicle moving along the railroad track at predetermined altitude towards a first portion of the railroad track, obtaining, from one or more cameras coupled to the aerial vehicle, first image data reproducible as an image of the first portion of the railroad track, identifying, based at least in part on the first image data, a first portion of a first rail and a first portion of a second rail of the railroad track, determining, based at least in part on the identified first portion of the first rail and the identified first portion of the second rail, a centerline of the first portion of the railroad track, generating, based at least in part on the determined centerline of the first portion of the railroad track, first flight instructions to cause the aerial vehicle to move relative to the first portion of the railroad track, with the aerial vehicle moving from the first portion of the railroad track towards a second portion of the railroad track, obtaining, from at least one of the one or more cameras coupled to the aerial vehicle, second image data reproducible as an image of the second portion of the railroad track, identifying, based at least in part on the second image data, a second portion of the first rail and a second portion of the second rail of the railroad track, determining, based at least in part on the identified second portion of the first rail and the identified second portion of the second rail, a centerline of the second portion of the railroad track, and generating, based at least in part on the determined centerline of the second portion of the railroad track, second flight instructions to cause the aerial vehicle to move relative to the second portion of the railroad track.

According to some implementations of the present disclosure, a method for autonomously navigating an aerial vehicle along a railroad track to a predetermined destination, the method comprising receiving GPS coordinates of the predetermined destination, initializing, using a flight controller, movement of the aerial vehicle from an initial position to a predetermined altitude, obtaining, from one or more cameras coupled to the aerial vehicle, first image data reproducible as an image of a first portion of the railroad track, determining, based on the first image data, a centerline of the first portion of the railroad track, generating, based at least in part on the determined centerline, flight instructions to cause the aerial vehicle to move relative to the railroad track, determining, using a GPS sensor configured to receive a GPS signal, a current location of the aerial vehicle, responsive to the GPS sensor being unable to receive a GPS signal, estimating, using an inertial sensor coupled to the aerial vehicle, a current location of the aerial vehicle, comparing the determined or estimated current location of the aerial vehicle to the predetermined destination to determine whether the aerial vehicle is at the predetermined destination, and responsive to determining that the aerial vehicle is at the predetermined destination, obtaining, from at least one of the one or more cameras coupled to the aerial vehicle, destination image data reproducible as an image of at least a portion of the railroad track at the predetermined destination.

According to some implementations of the present disclosure, a method for autonomously navigating an aerial vehicle to a predetermined destination along a railroad track includes receiving GPS coordinates of the predetermined destination, with the aerial vehicle moving along a centerline of the railroad track, determining, using a GPS sensor, a current location of the aerial vehicle, responsive to the GPS sensor being unable to receive GPS signals, estimating, using an inertial sensor coupled to the aerial vehicle, a current location of the aerial vehicle, and comparing the determined or estimated location of the aerial vehicle to the predetermined destination to determine whether the aerial vehicle is at the predetermined destination.

According to some implementations of the present disclosure, a system for autonomously navigating an aerial vehicle along a railroad track to a predetermined destination, the system comprising one or more cameras configured to generate image data reproducible as an image of a portion of the railroad track, and a flight controller including a memory device and one or more processors, the one or more processors being configured to identify, based at least in part on the image data, a portion of a first rail of the railroad track and a portion of a second rail of the railroad track, based at least in part on the identified portion of the first rail and the identified portion of the second rail, determine a centerline of the portion of the railroad track, and generate, based in at least in part on the determined centerline, flight instructions to cause the aerial vehicle to move along relative to the railroad track.

According to some implementations of the present disclosure, a system for autonomously navigating an unmanned aerial vehicle along a railroad track to a predetermined destination, the system comprising one or more cameras configured to generate image data reproducible as an image of a portion of the railroad track, one or more inertial sensors configured to generate signals indicative of motion of the aerial vehicle, a GPS sensor configured to receive GPS signals, a communication module configured (i) to receive GPS coordinates of the predetermined destination from a remote device and (ii) transmit image data generated by the one or more cameras to the remote device, and a flight controller including a memory device and one or more processors, the one or more processors being configured to analyze the image data to identify a centerline between a first rail and a second rail of the railroad track, generate, based at least in part on the determined centerline, flight instructions that cause the aerial vehicle to move relative to the railroad track, determine, based on GPS signals received by the GPS sensor, a current location of the aerial vehicle, estimate, based on signals from the inertial sensor and previously received aerial vehicle signals, a current location of the aerial vehicle, determine, based on the determined or estimated current location of the aerial vehicle and the received GPS coordinates of the predetermined destination, that that the aerial vehicle has reached the predetermined destination, responsive to determining that the aerial vehicle has reached the predetermined destination, obtaining, from at least one of the one or more cameras, destination image data reproducible as an image of a portion of the railroad track at the predetermined destination, and cause the communication module to transmit the destination image data to the remote device.

The above summary is not intended to represent each embodiment or every aspect of the present invention. Additional features and benefits of the present invention are apparent from the detailed description and figures set forth below.

### BRIEF DESCRIPTION OF THE DRAWINGS

FIG. 1 is a schematic block diagram of an aerial vehicle system according to some implementations of the present disclosure;

FIG. 2A is a side view of an aerial vehicle of the aerial vehicle system of FIG. 1 traveling along a railroad track according to some implementations of the present disclosure;

FIG. 2B is a plan view of the aerial vehicle of the aerial vehicle system of FIG. 2A traveling along the railroad track according to some implementations of the present disclosure;

FIG. 3 is a process flow diagram of a method for using the aerial vehicle system of FIG. 1 according to some implementations of the present disclosure;

FIG. 4 is a side view of an aerial vehicle system according to some implementations of the present disclosure;

FIG. 5 is a process flow diagram of a method for autonomously navigating an aerial vehicle along a railroad according to some implementations of the present disclosure;

FIG. 6A is an exemplary image of a portion of the railroad track of FIG. 2A including a first virtual path segment and a second virtual path segment according to some implementations of the present disclosure;

FIG. 6B is an exemplary image of a portion of the railroad track of FIG. 2A including a centerline according to some implementations of the present disclosure;

FIG. 7 is a schematic illustration of an aerial vehicle, an image plane, and a ground plane according to some implementations of the present disclosure; and

FIG. 8 is a top view of an aerial vehicle and a waypoint according to some implementations of the present disclosure.

While the disclosure is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Unmanned aerial vehicles (“UAVs”) can be used to aid in the inspection and maintenance of railroad tracks (e.g., subway tracks, elevated train tracks, high speed rail tracks, monorail tracks, tram tracks, etc.). Railroad tracks often develop defects (e.g., cracks, pitting, misalignment, missing track elements, etc.) over continued use which require corrective action (e.g., repair, replacement, etc.). Potential defects in the railroad track can be identified, for example, using a camera inspection system coupled to a railroad vehicle. Once a potential defect is identified, an inspector must often walk the railroad track by foot to confirm, evaluate, and/or ultimately repair the identified defect. This process can subject the inspection to safety risks and can be time and labor intensive, especially if there are multiple potential defects miles apart. For example, if a potential defect is located in a tunnel, it is both time consuming and can be dangerous for the inspector to walk by foot through the tunnel to reach the potential defect due to, for example, oncoming trains. Desirably, the inspector would only need to walk the track by foot when there is a confirmed defect that requires closer evaluation and/or corrective action by the inspector. Advantageously, autonomous aerial vehicle navigation systems and methods described herein can be used to quickly and safely confirm and/or evaluate the presence or absence of a defect on the railroad track without a human inspector having to physically travel to the potential defect, placing the inspector in harm's way. In addition, the autonomous aerial vehicle navigation systems and methods described herein can be used more generally to inspect the track for defects and/or obstructions, to patrol the track for trespassers, generate maps of railroad tracks and its surrounding environment (e.g., tunnel walls, ceilings, electrified rails, overhead power cables, track assets, etc.), etc.

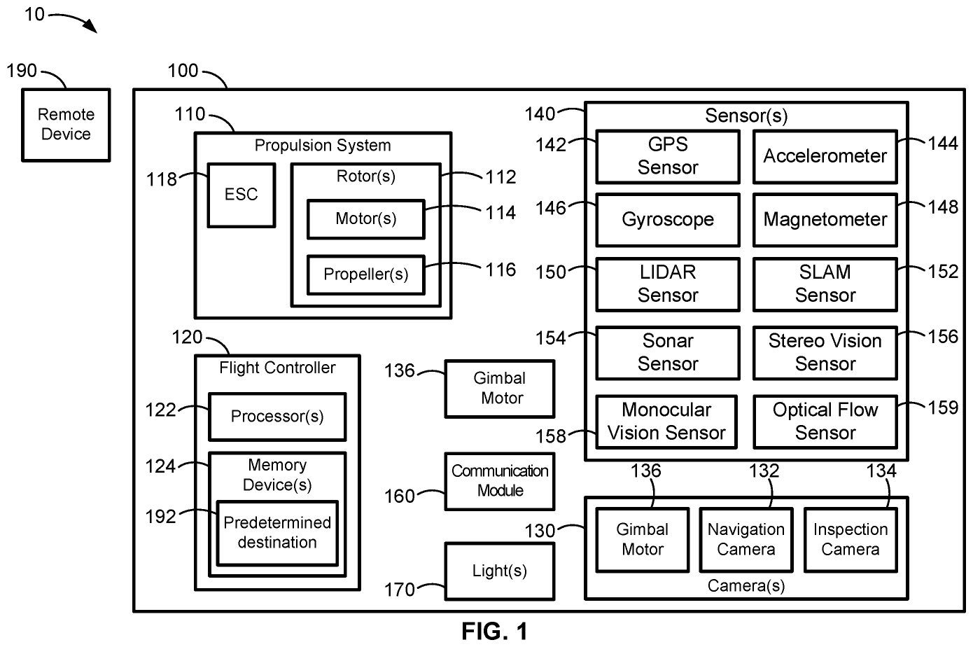

Referring to FIG. 1, an aerial vehicle system 10 includes an aerial vehicle 100 and a remote device 190. Generally, the aerial vehicle 100 autonomously navigates along a railroad track towards a predetermined destination (e.g., a location of interest along the railroad track) that is received from the remote device 190, without the need for a user to manually control the flight path of the aerial vehicle 100 and without the need for the aerial vehicle 100 to receive a preprogrammed flight path to reach the predetermined destination.

The aerial vehicle 100 includes a propulsion system 110, a flight controller 120, one or more cameras 130, an optional gimbal motor 136, one or more sensors 140, a communication module 160, and one or more optional lights 170.

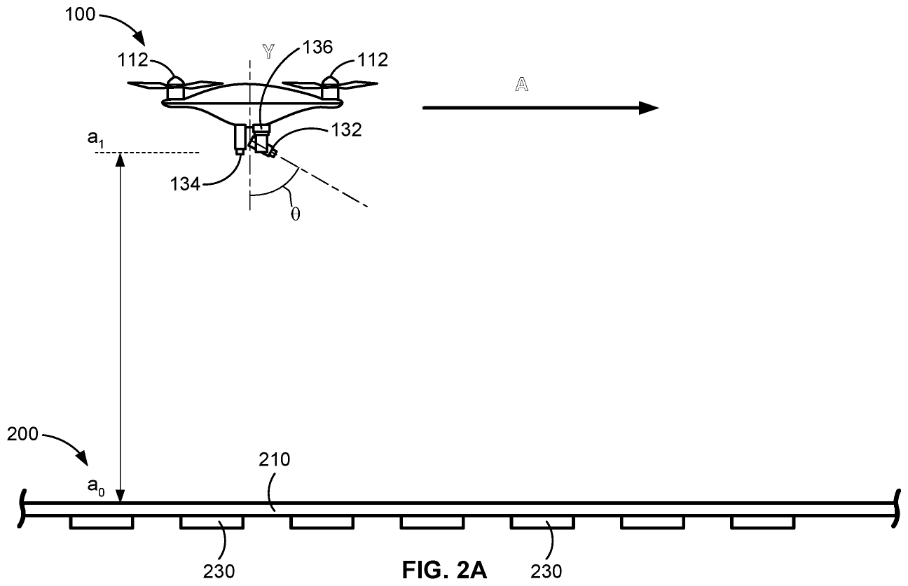

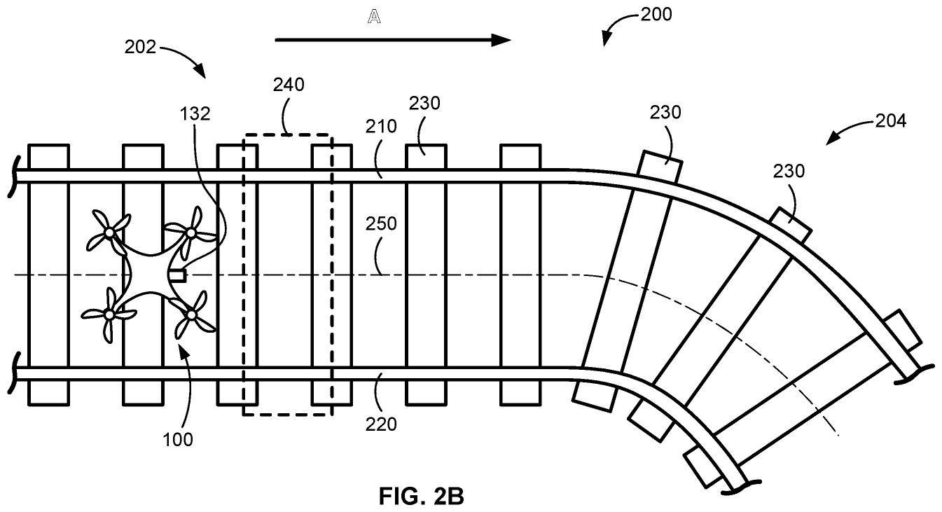

The propulsion system 110 is used to propel the aerial vehicle 100 for flight and/or hover. The propulsion system 110 includes one or more rotors 112 and an electronic speed controller (“ESC”) 118. Each rotor 112 includes a motor 114 that drives a propeller 116 to generate the necessary thrust for the aerial vehicle 100 to fly and/or hover. The ESC 118 translates flight instructions from the flight controller 120 to control the speed and orientation of the motor(s) 114 and propeller(s) 116 (e.g., throttle, pitch, roll, yaw, etc.). While the aerial vehicle 100 is shown in FIG. 2B as including four rotors, the propulsion system 110 of the aerial vehicle 100 can include any suitable number of rotors 112, such as, for example, one rotor, two rotors, three rotors, four rotors, six rotors, eight rotors, etc.

In some implementations, the aerial vehicle 100 can also include a fixed wing in addition to the rotor(s) 112, which is often referred to as a “hybrid fixed wing-rotor” configuration. In such implementations, the rotor(s) 112 generate thrust and the fixed wing generates lift. Alternatively, in other implementations, the aerial vehicle 100 can be a fixed wing platform that does not include rotor(s) 112. In such implementations, the aerial vehicle 100 includes wings that generate lift and a propulsion system (e.g., a motor and propeller, a jet engine, etc.) that generates thrust for flight. More generally, the aerial vehicle 100 can be any suitable aircraft.

The flight controller 120 generates flight instructions for the aerial vehicle 100 and includes one or more processors 122 and one or more memory devices 124. As shown, the flight controller 120 is communicatively coupled to the propulsion system 110, the camera(s) 130, one or more of the sensors 140, and the communication module 160. As described in further detail herein, at least one of the one or more memory device(s) 124 of the flight controller 120 receives (e.g., from the remote device 190 via the communication module 160) and stores a predetermined destination 192 (e.g., in the form of GPS coordinates). Based on data received from the camera(s) 130 and/or from one or more of the sensors 140, the processor(s) 122 generate flight instructions (e.g., throttle, pitch, roll, yaw, etc.) that are communicated to the propulsion system 110 to autonomously control the flight path of the aerial vehicle 100 without needing additional input from an operator (e.g., human) controlling the aerial vehicle using, for example, a remote controller.

The one or more camera(s) 130 of the aerial vehicle 100 includes a navigation camera 132 configured to generate image data reproducible as an image of a portion of a railroad track. The navigation camera 132 can be a line scan camera, area-scan camera, a video camera, a still camera, or the like, or any combination thereof. In some implementations, optional light(s) 170 can be aimed at the railroad track to aid the navigation camera 132 in generating image data reproducible as an image of a portion of a railroad track.

In some implementations, the one or more camera(s) 130 of the aerial vehicle 100 can include a thermal imaging camera (not shown) in addition to, or instead of, the inspection camera 134. In such implementations, the thermal imaging camera is configured to generate thermal image reproducible as one or more thermal images of a portion of the railroad track and/or its surroundings. The thermal image data can be analyzed by the processor(s) 122 of the flight controller 120, or can be transmitted to the remote device 190 via the communication module 160 for analysis, to determine temperature metrics, such as, for example, an average temperature within the thermal image, a maximum temperature within the thermal image, a minimum temperature within the thermal image, etc. The temperature metrics can then be used to identify one or more conditions of the railroad track 200 and/or its surroundings (e.g., standing water, electrical arching or leakage from a power rail, etc.)

Referring generally to FIGS. 2A and 2B, the navigation camera 132 is coupled to the aerial vehicle 100 such that the navigation camera 132 is aimed at a railroad track 200. The navigation camera 132 is configured to generate image data reproducible as one or more images of a portion of the railroad track 200. As shown, the railroad track 200 includes a first rail 210, a second rail 220, and a plurality of crossties 230 between the first rail 210 and the second rail 220. Further, the railroad track 200 includes a substantially straight section 202 and a substantially curved section 204. As best shown in FIG. 2B, the navigation camera 132 is aimed at the railroad track 200 such that the navigation camera 132 generates image data reproducible as an image of a first portion 240 of the railroad track 200. As shown, the first portion 240 of the railroad track 200 includes a portion of the first rail 210, a portion of the second rail 220, and at least a portion of one of the plurality of crossties 230. The navigation camera 132 is communicatively coupled to the flight controller 120, and the processor(s) 122 of the flight controller 120 are configured to analyze the image data of the first portion 240 of the railroad track to identify a path of the portion of the first rail 210 and a path of the portion of the second rail 220. Based on the position of the first rail 210 and the second rail 220, the processor(s) 122 of the flight controller 120 determine a centerline 250 of the railroad track 200 that is between the first rail 210 and the second rail 220. As described in further detail here, the flight controller 120 then generates flight instructions for the propulsion system 110 to cause the aerial vehicle 100 to travel generally along the centerline 250 of the railroad track 200. Alternatively, the flight controller 120 can generate flight instructions for the propulsion system 110 to cause the aerial vehicle 100 to travel generally along any other line (e.g., not necessarily a centerline) of the railroad track 200, such as, for example, generally along the first rail 210, generally along the second rail 220, generally along any line therebetween, etc.

As shown in FIG. 2A, the navigation camera 132 is mounted on the aerial vehicle 100 at an angle θ relative to vertical axis Y of the aerial vehicle 100. The angle θ can be adjusted such that the field of view of the navigation camera 132 is aimed at a portion of the railroad track that is a predetermined distance ahead (relative to arrow A) of a leading edge of the aerial vehicle 100. Increasing the angle θ causes the navigation camera 132 to be aimed at a portion of the railroad track that further ahead of the aerial vehicle 100 in the direction of travel compared to a smaller angle θ. Conversely, decreasing the angle θ causes the navigation camera 132 to be aimed at a portion of the railroad track 200 that is closer to the aerial vehicle 100 compared to a larger angle θ. The angle θ can be between about 0 degrees and about 90 degrees, between about 10 degrees and about 80 degrees, between about 20 degrees and about 70 degrees, between about 30 degrees and about 60 degrees, about 45 degrees, or any other suitable angle. Preferably, the angle θ is between about 30 degrees and about 60 degrees. The predetermined distance ahead of the leading edge of the aerial vehicle 100 can be, for example, 1 inch, 6 inches, 1 foot, 2 feet, 5 feet, 10 feet, 20 feet, or any other suitable distance.

In some implementations, the navigation camera 132 can be mounted to an optional gimbal motor 136 (FIG. 1) configured to move the navigation camera 132 with respect to three axes (pitch, roll, yaw) relative to the aerial vehicle 100 to thereby adjust the angle θ. In such implementations, the gimbal motor 136 is communicatively coupled to the flight controller 120 and adjusts the angle θ based on the current speed of the aerial vehicle 100. For example, if the aerial vehicle is moving quickly, the gimbal motor 136 can increase the angle θ (by adjusting the field of view or image plane of the navigation camera 132) such that the field of view of the navigation camera 132 is aimed further ahead of the aerial vehicle 100 in the direction of travel. This allows the flight controller 120 more time to generate flight instructions for the propulsion system 110 to cause the aerial vehicle 100 to continues to generally follow the centerline 250 or the desired flight path line of the railroad track 200 (e.g., as the aerial vehicle 100 moves, for example, from the substantially straight section 202 to the substantially curved section 204).

Additionally, the gimbal motor 136 can be used to adjust the field of view of the navigation camera 132 by, for example, adjusting the yaw of the field of view or image plane of the navigation camera 132 as the aerial vehicle 100 travels along, for example, substantially curved section 204 (FIG. 2B) of the railroad track 200. While the navigation camera 132 is shown as being aimed directly ahead of the aerial vehicle 100 in FIG. 2B, the gimbal motor 136 can cause the navigation camera 132 to move at an angle relative to a longitudinal axis of the aerial vehicle 100 that is between about 0 degrees and about 90 degrees, between about 10 degrees and about 80 degrees, between about 20 degrees and about 70 degrees, between about 30 degrees and about 60 degrees, about 45 degrees, or any other suitable angle.

In some implementations, the one or more camera(s) 130 optionally include the inspection camera 134. Like the navigation camera 132, the inspection camera 134 is configured to obtain image data reproducible as one or more images of a portion of the railroad track 200. As best shown in FIG. 2A, unlike the navigation camera 132 which is aimed in front of the aerial vehicle 100 (relative to arrow A), the inspection camera 134 is generally aimed at a portion of the railroad track 200 directly below the aerial vehicle 100. Images obtained by the inspection camera 134 can be analyzed by the processor(s) 122 of the flight controller 120 of the aerial vehicle 100 to identify potential defects in the railroad track 200 using machine vision and/or machine learning algorithms. Additionally or alternatively, the image data obtained by the inspection camera 134 can be transmitted to the remote device 190 via the communication module 160 of the aerial vehicle 100 for analysis/processing to identify the presence or absence of defects and/or other track conditions on the railroad track 200. The defects and/or other track conditions that can be identified include cracks, pitting defects (e.g., depressions defined in the rail head surface), grinding marks (e.g., marks left by rail grinding machines used to perform maintenance on the rails), flaking or spalling (e.g., pieces of surface material detaching from the rail head surface), missing track elements, cracked or broken track elements, fouled ballast, pooling of water, frayed electrical lines, or any combination thereof.

The navigation camera 132 and the inspection camera 134 can be the same, or different, types of cameras. For example, the navigation camera 132 can have a lower definition or resolution than the inspection camera 134 because the image data is simply being used by the flight controller 120 to determine the centerline or the desired flight path line of the railroad track 200, whereas image data from the inspection camera 134 is used to identify defects (e.g., defects that are potentially very small) on the railroad track 200 and may require a relatively higher resolution. Alternatively, in some implementations, rather than including the inspection camera 134 in the aerial vehicle 100, the image data generated by the navigation camera 132 can be analyzed/processed (e.g., using the flight controller 120, the remote device 190, or both) to identify the presence or absence of potential defects on the railroad track 200.

Referring back to FIG. 1, the one or more sensors 140 include a GPS sensor 142, an accelerometer 144, a gyroscope 146, a magnetometer 148, a light detection and ranging (“LIDAR”) sensor 150, a simultaneous localization and mapping (“SLAM”) sensor 152, a sonar sensor 154, a stereo vision sensor 156, a monocular vision sensor 158, and an optical flow sensor 159. While the one or more sensors 140 are shown and described as including each of these sensors, more generally, the one or more sensors 140 can include any combination and any number of each of the sensors described and/or shown herein.

The GPS sensor 142 is configured to receive GPS signals (e.g., from satellites) to determine a current location of the aerial vehicle 100 in the form of GPS coordinates (e.g., Universal Transverse Mercator (UTM) coordinates). The GPS sensor 142 is communicatively coupled to the flight controller 120 such that, as described in further detail herein, the processor(s) 122 can determine a current location of the aerial vehicle 100 and/or whether the aerial vehicle 100 has reached the predetermined destination based on data from the GPS sensor 142. Additionally, location data from the GPS sensor 142 can be stored in the memory device(s) 124 for later analysis (e.g., for estimating a current location when GPS data is unavailable), as described in further detail herein.

One or more of the accelerometers 144, one or more of the gyroscopes 146, and one or more of the magnetometers 148, or any combination thereof can be used collectively as an inertial sensor to generate data indicative of the flight movement of the aerial vehicle 100, such as, for example, linear acceleration, angular acceleration, pitch, roll, yaw, etc. In some implementations, the sensors 140 include three of the accelerometers and three of the gyroscopes where one of each corresponds to pitch, roll, and yaw, respectively. The inertial sensor is communicatively coupled to the flight controller 120, which is configured to analyze the data generated by the inertial sensor. For example, the flight controller 120 can analyze acceleration and/or orientation data from the inertial sensor to update the flight instructions to the propulsion system 110 (e.g., to stabilize the aerial vehicle 100 in windy conditions). Additionally, as described in further detail herein, acceleration and/or orientation data from the inertial sensor can be analyzed by the flight controller 120 in combination with previously recorded data from the GPS sensor 142 to estimate a current location of the aerial vehicle 100 when the GPS sensor 142 is unable to acquire a signal (e.g., when the aerial vehicle 100 is traveling through a tunnel or other dead zone).

The LIDAR sensor 150 and/or the SLAM sensor 152 are communicatively coupled to the flight controller 120 and are generally used to identify potential obstacles within the current flight path of the aerial vehicle 100. Potential obstacles along the railroad track 200 (FIGS. 2A and 2B) can include, for example, vegetation (e.g., tree, bush, grass, etc.) adjacent to the railroad track 200, fences adjacent to the railroad track 200, mileposts adjacent to the railroad track 200, switches of the railroad track 200, trains traveling along the railroad track 200 or adjacent railroad track(s), traffic (e.g., cars, trucks, pedestrians, etc.) traveling across the railroad track 200 or adjacent railroad track(s), or any combination thereof. Responsive to identifying a potential obstacle, the flight controller 120 updates the flight instructions to the propulsion system 110 to cause the aerial vehicle 100 to avoid the obstacle. For example, the updated flight instructions can cause the propulsion system 110 to increase or decrease the altitude of the aerial vehicle 100, move the aerial vehicle 100 to the left or right relative to the current flight path (e.g., by adjusting roll and/or yaw), stop further movement of the aerial vehicle 100 in the direction of arrow A (FIG. 2A) and cause the aerial vehicle 100 to hover, cause the aerial vehicle 100 to move in the opposite direction of arrow A (FIG. 2A), or any combination thereof.

The LIDAR sensor 150 emits pulsed laser light and measures the reflected pulses to determine a distance to a target object (e.g., a potential obstacle in the current flight path of the aerial vehicle 100). In addition to detecting obstacles within the flight path of the aerial vehicle 100, the LIDAR sensor 150 can be used to generate three-dimensional images of a target object and/or its surroundings. For example, the LIDAR sensor 150 can be used to generate a three-dimensional representation of the railroad track 200 and its surroundings, which can be stored in the memory device 124 and/or transmitted to the remote device 190 via the communication module 160. In addition to detecting obstacles, the SLAM sensor 152 can be used to generate a three-dimensional map of the railroad track 200 and its surroundings, which can be stored in the memory device 124 and/or transmitted to the remote device 190 via the communication module 160.

The sonar sensor 154 generates and/or emits sound waves (e.g., using a speaker) at a predetermined interval. The sonar sensor 154 detects reflections of the emitted sound waves (e.g., using a microphone) to determine a location of the aerial vehicle 100 and/or identify one or more obstacles in the current flight path of the aerial vehicle 100.

The stereo vision sensor 156 can be used to extract three-dimension information from two-dimension images, such as, for example, a distance between the aerial vehicle 100 and another object (e.g., the ground) for obstacle detection. Similarly, the monocular vision sensor 158 can be used for obstacle detection. The optical flow sensor 159 is generally used to determine a ground velocity of the aerial vehicle 100 (e.g., using ground texture and visible features). In some implementations, the optical flow sensor 159 is integrated in one or more of the cameras 130 described herein.

The communication module 160 can be communicatively coupled to the remote device 190 using any suitable wireless communication protocol or system, such as, for example, a radio-frequency (RF) communication system, a cellular network, or the like. The communication module 160 can include an antenna, a receiver (e.g., an RF receiver), a transmitter (e.g., an RF transmitter), a transceiver, or any combination thereof. The remote device 190 can be, for example, a smartphone, a tablet, a desktop or laptop computer, a server, a cloud server, or any combination thereof. The communication module 160 is communicatively coupled to the flight controller 120 (which in turn is communicatively coupled to the other components of the aerial vehicle 100) and can therefore transmit a variety of data regarding the status of the aerial vehicle 100, such as, for example, the current location of the aerial vehicle 100, the current air speed of the aerial vehicle 100, the remaining power or battery level, etc. In addition, the communication module 160 can transmit image data from the one or more camera(s) 130 to the remote device 190 for processing and/or analysis. While the communication module 160 of the aerial vehicle 100 is shown as being communicatively coupled only to remote device 190, more generally, the communication module 160 of the aerial vehicle 100 can be communicatively coupled to a plurality of remote devices (e.g., a smartphone and a server).

While the aerial vehicle 100 is shown in FIG. 1 as including all of the components described herein, more or fewer components can be included in an aerial vehicle. For example, an alternative aerial vehicle (not shown) includes the propulsion system 110, the flight controller 120, the navigation camera 132, the GPS sensor 142, and the communication module 160. Thus, various aerial vehicles can be formed using any portion of the components described herein.

While the railroad track 200 (FIGS. 2A and 2B) is shown as including first rail 210, second rail 220, crossties 230, the railroad track 200 can also include, for example, a third power rail, fasteners, joint-bars, ballast, etc. Further, in some implementations, the railroad track 200 includes an overhead power line for powering electrical railroad vehicles. In such implementations, the navigation camera 132 (FIG. 2B) the field of view or image plane of the navigation camera 132 can be adjusted (e.g., using gimbal motor 136 or repositioning the location where the navigation camera 132 is mounted to the aerial vehicle 100) such that rather than being aimed at the first rail 210 and/or second rail 220, the navigation camera 132 is aimed at the overhead power line. In this case, the navigation camera 132 can generate image data reproducible as one or more images of the overhead power line, and the processor(s) 122 of the flight controller 120 analyze the image data to determine a path of the overhead power line to and generate flight instructions such that the flight path of the aerial vehicle 100 substantially corresponds to the path of the overhead power line. The aerial vehicle 100 can fly at a predetermined altitude above or below the overhead power line (e.g., between 5 and 15 feet below the overhead power line, between 5 and 15 feet above the overhead power line, etc.)

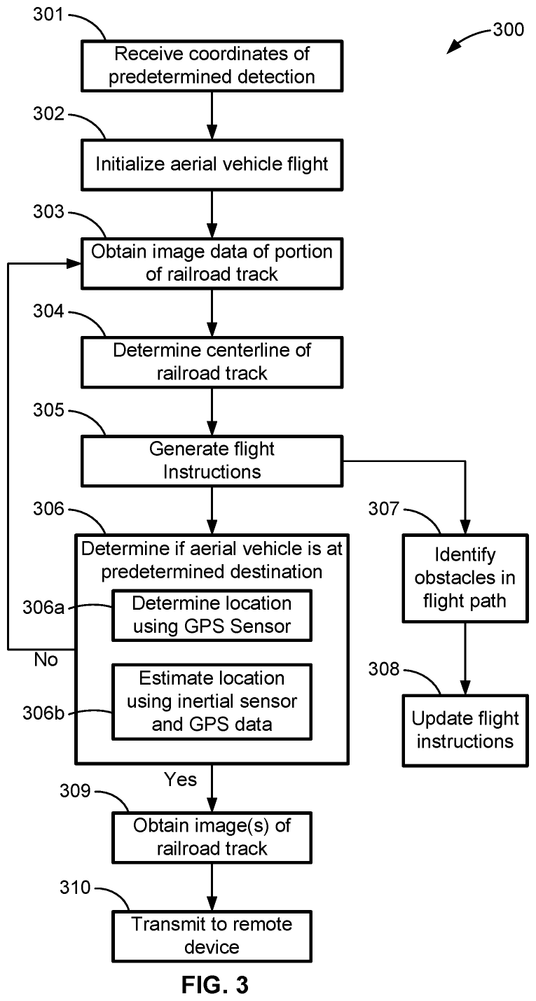

Referring to FIG. 3, a method 300 for autonomously navigating an aerial vehicle along a railroad track is illustrated. The method 300 can be used to autonomously navigate the aerial vehicle 100 of the aerial vehicle system 10 along the railroad track 200 (FIGS. 1-2B) to a predetermined destination (e.g., the location of a potential defect in the railroad track 200).

Step 301 of the method 300 includes receiving coordinates of a predetermined destination along the railroad track 200 for the aerial vehicle 100 to travel to. As described herein, the predetermined destination can be the location of an identified potential defect on the railroad track 200 that requires further evaluation (e.g., to confirm that the potential defect is an actual defect that requires repair or replacement). The potential defect on the railroad track 200 may be previously identified by a railroad inspection system that, for example, includes one or more inspection cameras and passes over and identified the potential defect on the railroad track. In some implementations, step 301 includes receiving a plurality of predetermined destinations along the railroad track 200 where, for example, each of the plurality of predetermined destinations is associated with a different potential defect in the railroad track 200. Moreover, while step 301 is shown as occurring prior to steps 302-312, more generally, step 301 can be repeated at any point during the method 300 to add one or more additional predetermined destinations and/or update the original predetermined destination.

In some implementations, a user inputs GPS coordinates of the predetermined location in the remote device 190, which then transmits the coordinates to the flight controller 120 via the communication module 160 of the aerial vehicle 100 (FIG. 1). The coordinates of the predetermined destination 192 are stored in the memory device(s) 124 of the flight controller 120. In other implementations, the GPS coordinates of the predetermined location may be automatically transmitted to the communication module 160 by the remote device 190 upon identification of a potential defect by an inspection system. For example, a railroad inspection system coupled to a railroad car may automatically transmit the GPS coordinates of an identified potential defect to the remote device 190, or directly to the communication module 160 of the aerial vehicle 100.

While the user may input GPS coordinates of the predetermined location for the flight controller 120, the user does not input flight instructions (e.g., a specific flight path) for the aerial vehicle 100. In other words, by inputting GPS coordinates, the user is telling the aerial vehicle 100 where to go, but not how to get there. For example, if the aerial vehicle 100 simply traveled to the predetermined using the shortest distance (e.g., a straight line), the aerial vehicle 100 would almost certainly encounter a series of obstacles (e.g., buildings, railroad structures, elevated terrain, etc.) that could cause the aerial vehicle 100 to crash. Even if the aerial vehicle 100 starts its flight path on the railroad track 200, the railroad track 200 often has a series of turns (e.g., curved portion 204 shown in FIG. 2B) such that if the aerial vehicle 100 simply flew the shortest distance (e.g., in a straight line) to the predetermined destination, the aerial vehicle 100 would not follow the path of the railroad track 200 and would likely encounter a series of obstacles.

Step 302 of the method 300 includes initializing flight of the aerial vehicle 100 from an initial position a₀ (FIG. 2A) to a predetermined altitude a₁ (FIG. 2A). In some implementations, during step 302, a user manually places the aerial vehicle 100 at the initial position a₀ on the railroad track 200. In such implementations, the initial position a₀ on the railroad track 200 can be on one of the plurality of crossties 230, on ballast between adjacent ones of the plurality of crossties 230, on the first rail 210, on the second rail 220, or generally adjacent to the railroad track 200. Accordingly, in some examples, the initial position can be between about 0 feet and about 5 feet, between about 0 feet and about 2 feet, between about 6 inches and about 2 feet, etc., above the ground. Advantageously, by manually placing the aerial vehicle 100 on the centerline 250 of the railroad track 200, the navigation camera 132 can easily identify the centerline 250 of the railroad track 200 once the aerial vehicle 100 reaches its predetermined altitude a₁.

Alternatively, in some implementations, a user can input the initial position (e.g., in the form of GPS coordinates) into the remote device 190, which subsequently transmits the initial position to the flight controller 120 via the communication module 160. The GPS coordinates of the initial position can correspond to the centerline 250 of the railroad track 200. Using the GPS sensor 142, the flight controller 120 then causes the aerial vehicle 100 to fly to the initial position. Advantageously, in such implementations, a user does not need to manually place the aerial vehicle 100 on the railroad track 200. Rather, the aerial vehicle 100 can be launched away from the railroad track 200, which reduces potential safety risks to the user and is less time consuming. For example, if a human user places the aerial vehicle 100 at a launch position that is spaced from the railroad track 200, the human user inputs the initial position on the railroad track 200, which causes the aerial vehicle 100 to fly from the launch position to the initial position using the shortest distance (e.g., in a straight line). The human user may also determine whether there are any potential obstacles in the straight line path between the launch position and the initial position, and adjust the launch position if needed (or, alternatively manually control the flight of the aerial vehicle 100 from the launch position to the initial position. Once the aerial vehicle 100 reaches the initial position on the railroad track 200, the aerial vehicle 100 autonomously navigates to the predetermined destination as described herein. In other words, the aerial vehicle 100 does not fly from the initial position to the predetermined destination by simply flying in a straight line, and instead follows the centerline of the railroad track 200 (which in some cases, can be straight line between the initial positon and predetermined destination).

The predetermined altitude a₁ (FIG. 2A) can be between about 2 feet and about 50 feet, between about 10 feet and about 30 feet, between about 20 feet and about 25 feet, or between about 5 feet and about 15, above the railroad track 200 (and the initial position a₀). Advantageously, the predetermined altitude a₁ (FIG. 2A) can be selected such that the aerial vehicle 100 is within the right-of-way clearance envelope of railroad vehicles that travel along the railroad track 200. In other words, if the predetermined altitude a₁ (FIG. 2A) of the aerial vehicle 100 is below the maximum clearance for railroad vehicles that are designed to travel along the railroad track 200, this can aid in reducing the risk of the aerial vehicle 100 striking potential obstacles (e.g., cross bridges, ceilings of tunnels, low hanging trees, etc.) as it travels along the centerline 250 or desired flight path line of the railroad track 200. The altitude of the aerial vehicle 100 can be determined by the flight controller 120 using a barometer (not shown) coupled to the aerial vehicle 100, the GPS sensor 142 (FIG. 1) of the aerial vehicle 100, or a combination of both.

Step 303 of the method 300 includes obtaining, from the navigation camera 132 (FIGS. 1-2B) image data reproducible as one or more images of a portion of the railroad track 200. For example, as shown in FIG. 2B, the navigation camera 132 can generate image data reproducible as one or more images of portion 240 of the railroad track 200. The image data from the navigation camera 132 is then received by the flight controller 120 of the aerial vehicle 100 (FIG. 1) for analysis.

Step 304 of the method 300 includes determining, based on the obtained image data from the navigation camera 132, a centerline of the railroad track 200. Once the flight controller 120 (FIG. 1) receives image data from the navigation camera 132, at least one of the one or more processor(s) 122 of the flight controller 120 analyzes the image data to identify a portion of the first rail 210 and the second rail 220 within the portion 240 of the railroad track 200 (FIG. 2B).

Based on the positions of the identified portion of the first rail 210 and the second rail 220, the processor(s) 122 determine the centerline 250 of the railroad track 200. For example, the processor(s) 122 can represent the path of both the first rail 210 and the second rail 220 as a plurality of points, and define the path of the centerline 250 as a plurality of points, where each of the plurality of points of the centerline 250 is substantially equidistant between corresponding pairs of points of the first rail 210 and the second rail 220. As shown in FIG. 2B, the centerline 250 is substantially straight for section 202 of the railroad track 200. When the aerial vehicle 100 moves in the direction of arrow A towards section 204 of the railroad track 200, which is substantially curved, the centerline is also curved. This is because the centerline 250 is determined by identifying a portion of the first rail 210 and the second rail 220 within the image data, determining a path of the first rail 210 and the second rail 220, and then determining the centerline 250 based on the determined paths of the first rail 210 and the second rail 220.

While the railroad track 200 is shown as only including the first rail 210 and the second rail 220 in FIG. 2B, the railroad track 200 is often adjacent to one or more other railroad tracks that are the same as, or similar to, the railroad track 200. For example, the railroad track 200 can include switches that allow railroad vehicles to move between the various sets of railroad tracks. If the navigation camera 132 is aimed at a portion of the railroad track 200 that includes a switch, the generated image of the railroad track 200 may include a portion of the first rail 210, a portion of the second rail 220, and a portion of a switch rail (not shown). In this case, the processor(s) 122 of the flight controller 120 may identify portions of all three rails. To identify the true centerline 250 of the railroad track 200 (which is between the first rail 210 and the second rail 220), the processor(s) 122 can be configured to filter out the portion of the switch rail by, for example, determining a distance between combinations of the identified portions of the first rail 210, the second rail 220, and the switch rail. In this example, a predefined railroad track gauge (i.e., distance between the first rail 210 and the second rail 220) for the railroad track 200 can be stored in the memory device(s) 124. By using the track gauge, the processor(s) 122 can identify which two of the three identified rails are the first rail 210 and the second rail 220, and subsequently determine the true centerline 250 of the railroad track 200.

Step 305 of the method 300 includes generating, using the flight controller 120, flight instructions for the propulsion system 110 of the aerial vehicle 100 (e.g., throttle, pitch, roll, yaw, etc.) such that the flight path of the aerial vehicle 100 substantially corresponds to the determined centerline 250 or desired flight path line of the railroad track 200. For example, as the aerial vehicle 100 travels along the substantially straight section 202 of the railroad track 200 (FIG. 2B), the flight controller 120 generates flight instructions that keep the aerial vehicle 100 traveling substantially straight at the predetermined altitude a₁ (FIG. 2A) along the centerline 250 in the direction of arrow A towards the predetermined destination. As the aerial vehicle 100 reaches the substantially curved portion 204 of the railroad track 200 (FIG. 2B), the flight controller 120 generates flight instructions to turn the aerial vehicle 100 (e.g., by adjusting yaw of the rotor(s) 112) to cause the flight path of the aerial vehicle 100 to substantially correspond to the centerline 250 or desired flight path line of the substantially curved portion 204, which is different than the centerline 250 for the substantially straight portion 202. The flight path of the aerial vehicle 100 can substantially correspond to the centerline 250 of the railroad track 200 such that the Y axis (FIG. 2A) of the aerial vehicle 100 is within between about 0 inches and about 2.5 feet, between about 2 inches and about 2 feet, between about 6 inches and about 1 foot, etc., on either side of the centerline 250 of the railroad track 200.

Step 306 includes determining whether the aerial vehicle 100 has reached the predetermined destination by performing one or both of sub-steps 306a and 306b. Sub-step 306a includes determining the current location of the aerial vehicle using the GPS sensor 142 (FIG. 1). The GPS sensor 142 receives a GPS signal (e.g., from a satellite) from which the flight controller 120 can determine the location of the aerial vehicle 100 (e.g., its GPS coordinates). Once the current location of the aerial vehicle 100 is determined, step 306 includes comparing the determined current location of the aerial vehicle 100 to the predetermined location. If the determined current location of the aerial vehicle 100 is not the same as the predetermined location, steps 303-305 are continuously repeated until the aerial vehicle 100 reaches the predetermined destination. If the determined current location of the aerial vehicle 100 is the same the predetermined location (or within a predefined threshold distance, such as, for example, 2 feet, 5 feet, 10 feet, etc.), the method 300 optionally continues to step 309, as described in further detail herein.

However, if the aerial vehicle 100 is flying through a GPS dead zone (e.g., a railroad tunnel), the GPS sensor 142 may not be able to receive a GPS signal from which the current location of the aerial vehicle 100 can be determined. In this case, sub-step 306b includes estimating the current location of the aerial vehicle 100 based on data generated by the inertial sensor (e.g., including the accelerometer 144, the gyroscope 146, the magnetometer 148, or any combination thereof) and previously recorded location data from the GPS sensor 142. For example, before the aerial vehicle 100 enters a tunnel and the GPS sensor 142 loses its connection, the last known location of the aerial vehicle determined from the GPS sensor 142 is stored in the memory device(s) 124 of the flight controller 120 (FIG. 1). Based on data generated by the inertial sensor (e.g., the accelerometer 144, the gyroscope 146, the magnetometer 148, or any combination thereof), the flight controller 120 can determine a distance traveled by the aerial vehicle 100 after the GPS signal is lost. Based on the last known GPS coordinates stored in the memory device 124 and the data from the inertial sensor, the flight controller 120 can estimate a current location of the aerial vehicle 100. As the time that the GPS sensor 142 is unable to acquire a signal (e.g., the longer the dead zone or tunnel) increases, the accuracy of the estimated location of the aerial vehicle 100 decreases. However, advantageously, as described herein, steps 303-305 are continuously repeated such that the flight path of the aerial vehicle 100 continues to substantially correspond to the centerline of the railroad track. Thus, the aerial vehicle 100 can continue to autonomously and safely navigate along the railroad track even if the GPS sensor 142 cannot acquire a GPS signal.

In some implementations, the aerial vehicle 100 includes a radio frequency identifier (RFID) antenna (not shown) configured to receive location information from one or more RFID tags placed adjacent to the railroad track (e.g., on one or more rails, on a crosstie, on a post adjacent to the railroad track, on an overhead signal spanning the railroad track, on the walls of a railroad tunnel, etc.). Each the location information received from the RFID tags can correspond to mile markers, landmarks, railroad assets/equipment, certain GPS coordinates, etc. In such implementations, the flight controller 120 of the aerial vehicle 100 can accurately determine the current location of the aerial vehicle 100 from the RFID tags without the need for GPS signals (GPS sensor 142) or motion data (e.g., the accelerometer 144, the gyroscope 146, the magnetometer 148, or any combination thereof).

Step 307 includes identifying potential obstacles within the current flight path of the aerial vehicle 100 using the obstacle detection sensor 150 (FIG. 1). As described herein, the aerial vehicle 100 travels along the centerline 250 of the railroad track 200 (FIG. 2B) at a predetermined altitude al (FIG. 2A), where the predetermined altitude is preferably within the right-of-way clearance of railroad vehicles that travel along the railroad track 200. Flying at this altitude generally minimizes the risk that the aerial vehicle 100 will strike an obstacle. For example, because railroad tunnels and overhead signals are designed with a certain clearance for railroad vehicles, the flight controller 120 does not need to adjust the flight path of the aerial vehicle 100 to cause the aerial vehicle 100 to avoid overhead obstacles like signals or tunnels.

However, railroad vehicles often automatically trigger safety measures to avoid collisions, such as, for example, railroad crossing gates. Unlike the railroad vehicle which is generally fixed relative to the railroad track and difficult to quickly stop or reverse, the aerial vehicle 100 can change its altitude, position relative to the railroad track, and/or air speed to avoid obstacles, such as vehicle traffic crossing the railroad track 200. To this end, the obstacle detection sensor 150 of the aerial vehicle 100 can be used to identify vehicles within the flight path of the aerial vehicle 100 at a railroad crossing and/or oncoming trains. Thus, the aerial vehicle 100 can safely and autonomously navigate to the predetermined destination without the need to activate certain safety measures like a standard railroad vehicle (e.g., crossing gates). Other potential obstacles along the railroad track 200 that can be detected and avoided include, for example, vegetation adjacent to the railroad track 200, fences adjacent to the railroad track 200, mileposts adjacent to the railroad track 200, switches of the railroad track 200, trains traveling along the railroad track 200 or adjacent railroad track(s), or any combination thereof.

Responsive to identifying a potential obstacle during step 307, the method 300 proceeds to step 308, which includes updating the flight instructions generated by the flight controller 120 such that the propulsion system 110 causes the aerial vehicle 100 to avoid the obstacle. For example, the updated flight instructions can cause the propulsion system 110 to increase or decrease the altitude of the aerial vehicle 100 (e.g., by increasing throttle of rotor(s) 112 (FIG. 1), move the aerial vehicle 100 to the left or right relative to the centerline 250 of the railroad track 200 (e.g., four feet away from the centerline 250 such that the aerial vehicle is outside the area between the first rail 210 and the second rail 220), stop further movement of the aerial vehicle 100 in the direction of arrow A (FIG. 2A) and cause the aerial vehicle 100 to hover, or cause the aerial vehicle 100 to move in the opposite direction of arrow A (FIG. 2A). Once the obstacle is avoided (e.g., after a predefined time period), the flight controller 120 causes the aerial vehicle 100 to return to its flight path at the predetermined altitude a₁ (FIG. 2A) along the centerline 250 (FIG. 2B) of the railroad track 200.

In some implementations, the method 300 optionally includes steps 309 and 310. Subsequent to determining that the aerial vehicle 100 is at the predetermined location during step 306 described above, step 309 includes obtaining image data reproducible as one or more images of the railroad track 200 at the predetermined destination. The image data of the railroad track at the predetermined destination can be obtained from the navigation camera 132, the optional inspection camera 134, or both. Step 310 includes transmitting the image data for the predetermined destination to the remote device 190 (FIG. 1) via the communication module 160 of the aerial vehicle 100. As described herein, in some implementations, the predetermined destination along the railroad track corresponds to a potential defect in the railroad track. A user of the remote device 190 evaluates the image data obtained at the predetermined location to determine whether there is in fact a defect at the predetermined location that requires further action by the user.

Alternatively, in some implementations, rather than only transmitting image data to the remote device 190 subsequent to the aerial vehicle 100 reaching the predetermined destinations, the communication module 160 of the aerial vehicle 100 can transmit image data from the camera(s) 130 while the aerial vehicle 100 is traveling to the predetermined destination. The transmission of image data can be continuous (e.g., a continuous live feed of the railroad track in front of the aerial vehicle 100) or selective (e.g., the communication module 160 transmits image data every 30 seconds, every 2 minutes, every 5 minutes, etc.).

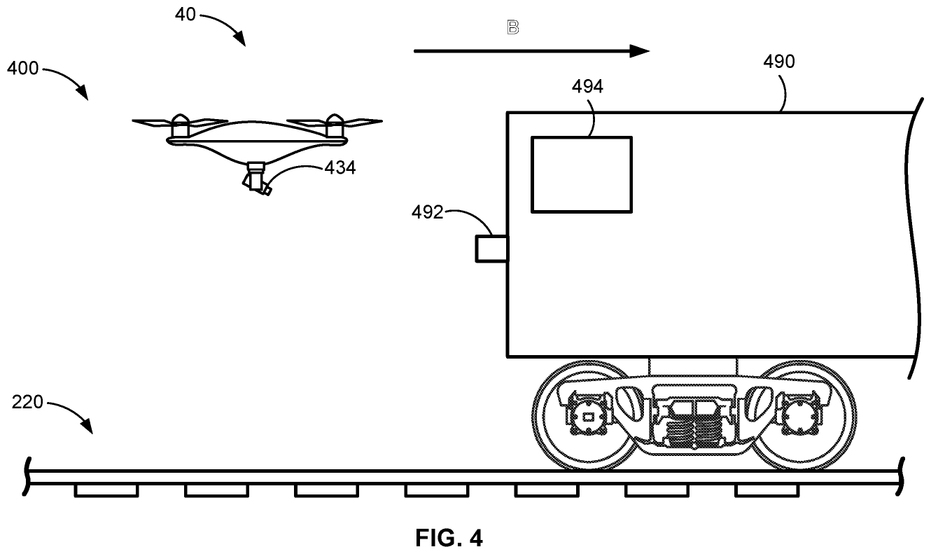

Referring to FIG. 4, an autonomous aerial vehicle navigation system 40 that is similar to the autonomous aerial vehicle navigation system 10 (FIG. 1) includes an aerial vehicle 400 and a railroad vehicle 490. Generally, the autonomous aerial vehicle navigation system 40 uses a virtual tether between the aerial vehicle 400 and the railroad vehicle 490 such that the aerial vehicle 400 navigates by following the railroad vehicle 490 at a predetermined distance as the railroad vehicle 490 travels along the railroad track 200. The railroad vehicle 490 can be, for example, a locomotive, a railcar, a passenger car, a freight car, a railroad vehicle, a road vehicle (e.g., a vehicle configured to operate on both railroad tracks and a conventional surface road), etc.

The aerial vehicle 400 is similar to the aerial vehicle 100 (FIG. 1) described herein in that the aerial vehicle 400 includes a propulsion system that is the same as, or similar to, the propulsion system 110, a flight controller that is the same as, or similar to, the flight controller 120, one or more camera(s) that are the same as, or similar to, the one or more camera(s) 130, a GPS sensor that is the same as, or similar to, the GPS sensor 142, an inertial sensor that is the same as, or similar to, the inertial sensor described above (e.g., the accelerometer 144, the gyroscope 146, the magnetometer 148, or any combination thereof), and a communication module that is the same as, or similar to, the communication module 160. More specifically, the one or more cameras of the aerial vehicle 400 includes a navigation camera 432 that is the same as, or similar to, the inspection camera 132 of the aerial vehicle 100 (FIGS. 1-2B). The aerial vehicle 400 can also optionally include an obstacle detection sensor that is the same, or similar to, the obstacle detection sensor 150 (FIG. 1) described herein and one or more lights.

The aerial vehicle system 40 differs from the aerial vehicle system 10 in that the aerial vehicle 400 autonomously navigates along the railroad track 200 by following the railroad vehicle 490, rather than obtaining images of the railroad track 200 and determining a centerline of the railroad track 200 to generate flight instructions. The navigation camera 432 is configured to obtain image data reproducible as one or more images of at least a portion of the railroad vehicle 490. The navigation camera 432 is communicatively coupled to the processor(s) of the flight controller of the aerial vehicle 400, which are configured to identify the outer edges of the rear of the railroad vehicle 490. The processor(s) of the flight controller generate flight instructions to cause the aerial vehicle 400 flying within the outer edges of the rear of the railroad vehicle 490 (e.g., between the first rail 210 and the second rail 220 along which the railroad vehicle 490 is traveling) at a predetermined distance from the rear of the railroad vehicle 490.

In some implementations, the railroad vehicle 490 includes one or more visual markers 492. The image data obtained by the navigation camera 432 is reproducible as one or more images of the visual markers 492, which can aid in identifying flight instructions for the aerial vehicle 400. For example, if the one or more visual markers 492 includes three markers, the processor(s) of the flight controller can identify the three markers within the image data and generate flight instructions to cause the aerial vehicle 400 to fly within an area defined by the three markers. The one or more visual markers 492 can include, for example, one marker, two markers, three markers, four markers, six markers, ten markers, etc., can have any shape, such as, for example, a circular shape, an oval shape, a triangular shape, a polygonal shape, etc., and can have any color (e.g., red, green, yellow, blue, etc.) to aid the processor(s) of the flight controller in identifying the one or more visual markers 492 within image data.

In addition, the processor(s) of the flight controller can determine a current distance between the aerial vehicle 400 and the railroad vehicle 490 based on the image data from the navigation camera 432 and generate flight instructions to cause the aerial vehicle 400 to follow the railroad vehicle 490 at a predetermined distance (e.g., between about 2 feet and 100 feet, between about 5 feet and about 50 feet, between about 10 feet and about 30 feet, etc. Advantageously, by causing the flight path of the aerial vehicle 400 to be within an area defined by the outer edges of the rear of the railroad vehicle 490 (or another area defined by the one or more markers 492) at the predetermined distance, the aerial vehicle 400 can autonomously navigate along the railroad track 200 with a minimal risk of striking any obstructions or obstacles.

In some implementations, in addition to, or instead of, using the navigation camera 432 to generate image data of a portion of the railroad vehicle 490 to generate flight instructions for the aerial vehicle 400, the railroad vehicle 490 can include a communication module 494 configured to wirelessly communicate with the communication module of the aerial vehicle 400 to establish a so-called “virtual tether.” In some implementations, the communication module 494 of the railroad vehicle 490 wirelessly communicates with the communication module of the aerial vehicle 400 using a radio frequency (“RF”) signal from which the distance between the aerial vehicle 400 and the railroad vehicle 490 can be determined. In another example, the communication module 494 can transmit GPS coordinates of the railroad vehicle 490 to the communication module of the aerial vehicle 400. The flight controller can then determine, using the GPS sensor of the aerial vehicle, the relative position of the aerial vehicle 400 relative to the railroad vehicle 490 and generate flight instructions to cause the aerial vehicle 400 to fly a predetermined distance from the railroad vehicle 490 at a predetermined altitude.

As described herein, the aerial vehicle 400 and the railroad vehicle 490 may travel along the railroad track 200 through a GPS restricted area (e.g., a tunnel). Thus, in some implementations, the communication module of the railroad vehicle 490 and the communication module of the aerial vehicle transmit signals between one another such that the processor(s) of the flight controller of the aerial vehicle can determine a location of the railroad vehicle 490 relative to the aerial vehicle 400. Once the location of the railroad vehicle 490 relative to the aerial vehicle 400 is determined, the flight controller generates flight instructions to cause the aerial vehicle 400 to fly at a predetermined distance from the railroad vehicle 490 at a predetermined altitude. For example, the flight controller of the aerial vehicle 400 can determine a distance between the aerial vehicle 400 and the railroad vehicle 490 based on a time delay between the signals between transmitted between the communication modules of the aerial vehicle 400 and railroad vehicle 490.

In other implementations, the aerial vehicle 400 includes an obstacle detection sensor that is the same as, or similar to, the obstacle detection sensor 150 (FIG. 1), such as a LIDAR sensor or a SLAM sensor. In such implementations, the obstacle detection sensor can be used to determine a location of the railroad vehicle 490 relative to the aerial vehicle 400 such that the flight controller can generated flight instructions to cause the aerial vehicle 400 to follow the railroad vehicle 490 along the railroad track 200 at a predetermined distance and altitude.

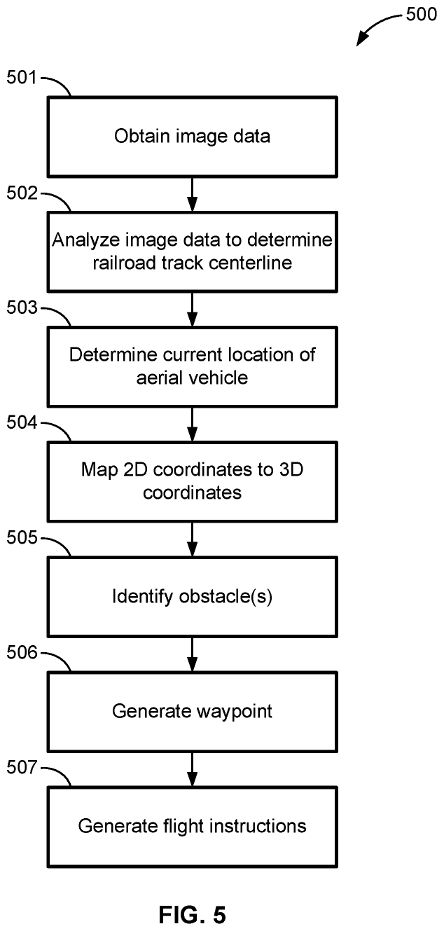

Referring to FIG. 5, a method 500 for autonomously navigating an aerial vehicle along a railroad track is illustrated. The method 500 can be implemented using the system 10 (FIG. 1) described herein.

Step 501 of the method 500 is the same as, or similar to, step 303 of the method 300 (FIG. 3) and includes obtaining image data reproducible as one or more images of a portion of the railroad track (e.g., railroad track 200 of FIGS. 2A and 2B). The image data can be obtained, for example, using the navigation camera 132 (FIG. 1) of the aerial vehicle 100 and stored in the memory 124 (FIG. 1).

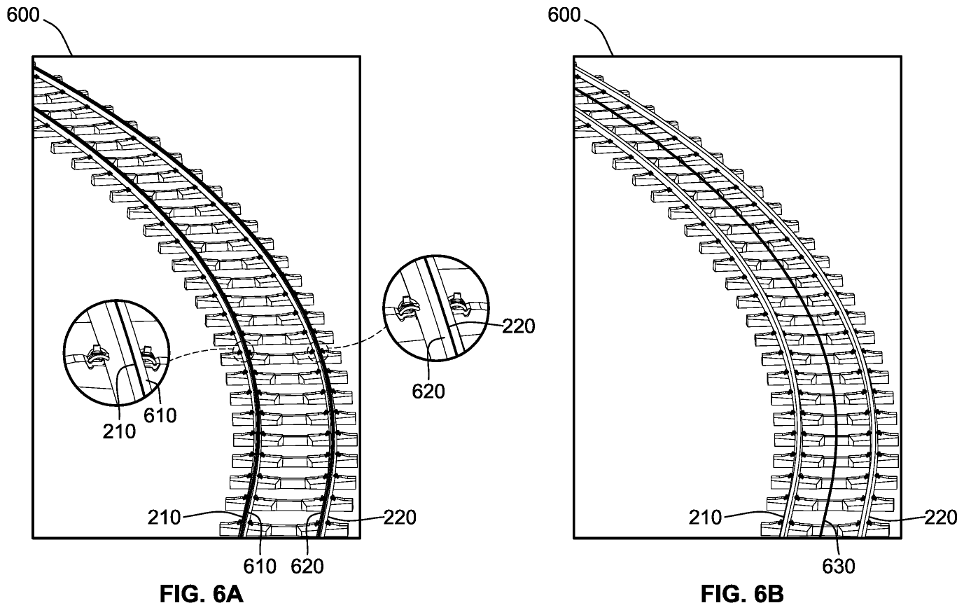

Step 502 of the method 500 is similar to step 304 of the method 300 (FIG. 3) and includes analyzing the image data obtained during step 501 to determine a centerline of the railroad track. As described above, the image data (step 501) is reproducible as one or more images of a portion of the railroad. Referring to FIG. 6A, an exemplary image 600 of a portion of the railroad track 200 is shown. To identify the centerline of the railroad track, the flight controller 120 analyzes (e.g., using semantic segmentation) the image 600 to identify a first virtual path segment 610 for the first rail 210 and a second virtual path segment 620 for the second rail 220. In FIG. 6A, the first virtual path segment 610 and the second virtual path segment 620 are virtually overlaid as a line (e.g., a curved line, a straight line, etc., or any combination thereof) on the first rail 210 and the second rail 220 of in the image 600.

Various image segmentation techniques can be used to identify the first virtual path segment 610 and the second virtual path segment 620, such as, for example, a deep-learning segmentation algorithm, a Naïve Bayes Classifier, mean-shift cluster, graph-based algorithms, neural networks (e.g., convolutional neural networks), or any combination thereof. The Naïve Bayes Classifier technique is advantageous because it requires less image data (e.g., compared to a deep-learning algorithm) and less processing power relative to a deep-learning segmentation algorithm (e.g., freeing the processor to perform other tasks). The deep-learning segmentation algorithm can be trained to identify the path segments using supervised machine learning techniques.

Once the first virtual path segment 610 and the second virtual path segment 620 (FIG. 6A) are identified in the image 600, the centerline of the railroad track be determined using the techniques described herein. Referring to FIG. 6B, a centerline 630 is virtually overlaid as a line (e.g., a curved line, a straight line, etc., or any combination thereof) on the railroad track 200 in the image 600. In this example, the portion of the railroad track 200 in the image 600 is substantially curved. In this case, the centerline 630 (and the first virtual path segment 610 and the second virtual path segment 620) are also curved. Creating a curved representation includes detecting edges of the first virtual path segment 610 and the second virtual path segment 620 and curve fitting the edge points to produce a smoothed, curved representation of the centerline 630.

Step 503 of the method 500 is similar to step 306 of the method 300 (FIG. 3) and includes determining a current location of the aerial vehicle 100 (FIG. 1) relative to a fixed map (e.g., a global map, a local map, etc.). Information describing the fixed map can be stored in the memory device 124 of the flight controller 120. The current location of the aerial vehicle 100 can be determined, for example, using the GPS sensor 142 described herein (FIG. 1) and expressed as GPS coordinates. As described herein, other ones of the sensors 140 (FIG. 1) (e.g., the accelerometer 144, the gyroscope 146, the magnetometer 148, the LIDAR sensor 150, the sonar sensor 154, the stereo vision sensor 156, the optical flow sensor 159, or any combination thereof) can be used to determine and/or estimate the current location of the aerial vehicle 100 if a GPS signal is unavailable.

Step 504 of the method 500 includes mapping two-dimensional (2D) coordinates from the image data (step 501) to three-dimensional (3D) coordinates. As described above, step 502 includes determining the centerline 630 of the railroad track 200 in the image 600 (FIG. 6). Step 504 includes converting the 2D (two-dimensional) coordinates of the centerline 630 in the image 600 to 3D (three-dimensional) coordinates based on one or more properties of the navigation camera 132 (e.g., focal length, center of projection, etc.), a current altitude or height of the aerial vehicle 100 relative to the ground, and a pose of the camera 132 relative to a fixed frame of reference.

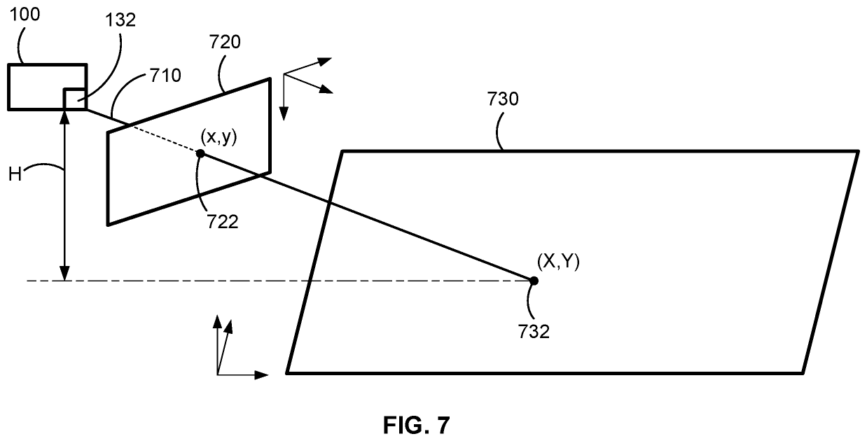

For example, referring to FIG. 7, the aerial vehicle 100 is illustrated schematically at a height H relative to ground. A camera axis 710 of the navigation camera 132 passes through an image plane 720 and a ground plane 730. As shown, the camera axis 710 intersects the image plane 720 at a first point 722 (x, y) and intersects the ground plane 730 at a second point 732 (X, Y). The relationship between the 2D coordinates in the image (e.g., first point 722) and the 3D coordinates on the ground (e.g., second point 732) can be determined using a homograph transform H_{3×3} defined by Equation 1 below:

$$α ( \begin{matrix}x \\ y \\ 1\end{matrix} ) = ( \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ) ( \begin{matrix}X \\ Y \\ 1\end{matrix} ) \qquad Equation 1$$

The values of the homograph matrix in Equation 1 can be calculated using intrinsic and extrinsic calibration parameters, as set forth below in Equation 2.

H=α(K*R+t) Equation 2

In Equation 2, K is the intrinsic matrix, R is the rotation matrix, and t is the translation vector.

Step 505 of the method 500 is the same as, or similar to, step 307 of the method 300 (FIG. 3) and includes identifying one or more obstacles within the flight path of the aerial vehicle. As described above, obstacles can be detected using the navigation camera 132, the LIDAR sensor 150, the SLAM sensor 152, or any combination thereof.

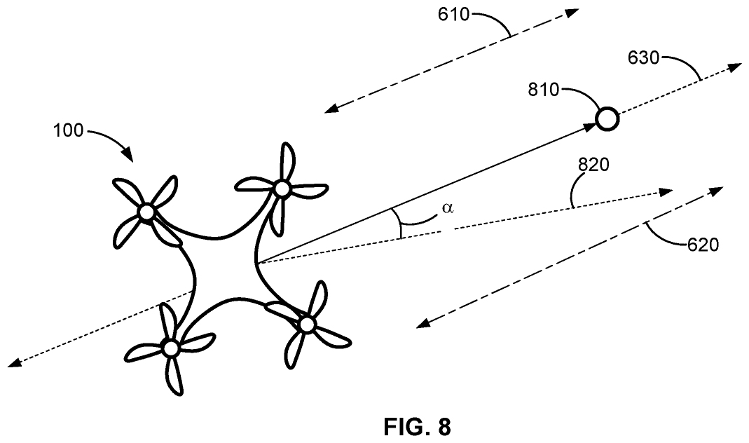

Step 506 of the method 500 includes generating a waypoint based on the current location of the aerial vehicle (step 503), the mapped 3D coordinates (step 504), and/or the identified obstacles (step 505). Referring to FIG. 8, a waypoint 810 is positioned along the centerline 630 of the railroad track (e.g., between the first virtual path segment 610 and the second virtual path segment 620). If the current GPS coordinates of the aerial vehicle 100 relative to the fixed map are known (step 503), the waypoint 810 is expressed as the GPS coordinates of the railroad track centerline line relative to the fixed map.

Step 507 of the method 500 includes generating flight instructions for the aerial vehicle. More specifically, the flight controller 120 (FIG. 1) generates flight instructions for the propulsion system 110 of the aerial vehicle 100 (e.g., throttle, pitch, roll, yaw) to move the aerial vehicle 100 towards the waypoint 810 generated during step 506. For example, the generated flight instructions can cause the aerial vehicle 100 to move to the GPS coordinates associated with the generated waypoint 810 (step 506). If the current location of the aerial vehicle 100 cannot be determined in terms of GPS coordinates relative to the fixed map (e.g., the current location is estimated based on inertial data) based on an angle between the centerline waypoint and the current flight direction of the aerial vehicle 100. For example, referring to FIG. 8, a current flight path 820 of the aerial vehicle 100 is offset from the waypoint 810 by an angle a. In this example, if the angle a is greater than zero (e.g., a positive angle), the generated flight instructions turn (e.g., yaw) the aerial vehicle 100 to the left (relative to the direction of travel). Conversely, if the angle a is less than zero (e.g., a negative angle), the generated flight instructions turn (e.g., yaw) the aerial vehicle 100 to the right (relative to the direction of travel).

Steps 501-507 of the method 500 can be repeated one or more times to autonomously navigate the aerial vehicle along any length of the railroad track (e.g., 10 feet, 500 feet, 1 mile, 10 miles, 50 miles, etc.) Each determined waypoint (step 506) can be spaced from previous and subsequent waypoints by a predetermined interval (e.g., every 1 foot, every 10 feet, every 50 feet, every 100 feet, etc.).

While the aerial vehicle system 10 and the aerial vehicle system 40 have been described herein as being used to navigate aerial vehicles 100, 400 along a railroad track, more generally the aerial vehicle system 10, 40 can be used to autonomously navigate aerial vehicles along other paths. For example, in some implementations, the aerial vehicle systems described herein can be used to autonomously navigate an aerial vehicle along a road by determining a centerline line between traffic stripes, curbs, medians, dividers, rumble strips, reflectors, or any combination thereof. In such implementations, the navigation camera or a separate inspection camera of the aerial vehicle can monitor vehicle traffic or inspect the roadway for defects.

It is expressly contemplated that one or more elements or any portion(s) thereof from any of the systems and methods described herein can be combined with one or more elements or any portion(s) thereof from any of the other ones of the systems and methods described herein to form one or more additional alternative implementations of the present disclosure. It is expressly contemplated that one or more elements or any portion(s) thereof from any of the claims 1-56 below can be combined with one or more elements or any portion(s) thereof from any of the other ones of the claims 1-56 to form one or more additional alternative implementations of the present disclosure.

While the present disclosure has been described with reference to one or more particular embodiments or implementations, those skilled in the art will recognize that many changes may be made thereto without departing from the spirit and scope of the present disclosure. Each of these embodiments or implementations and obvious variations thereof is contemplated as falling within the spirit and scope of the present disclosure. It is also contemplated that additional embodiments implementations according to aspects of the present disclosure may combine any number of features from any of the embodiments described herein.

What is claimed is:

1. A method for autonomously navigating an aerial vehicle along a railroad track, the method comprising:
obtaining, from one or more cameras coupled to the aerial vehicle, image data reproducible as an image of a portion of the railroad track;
identifying, based at least in part on the image data, a first rail and a second rail of the portion of the railroad track;
determining, based at least in part on the identified first and second rails of the portion of the railroad track, a centerline of the portion of the railroad track; and
generating, based at least in part on the determined centerline, flight instructions to cause the aerial vehicle to move relative to the railroad track.

2. The method of claim 1, further comprising, subsequent to the aerial vehicle moving relative to the railroad track, repeating the obtaining, the identifying, and determining to generate additional flight instructions to cause the aerial vehicle to continue to move relative to the railroad track until the aerial vehicle reaches a predetermined location.

3. The method of claim 1, further comprising initializing, using a flight controller, movement of the aerial vehicle from an initial position to a predetermined altitude above the railroad track wherein the predetermined altitude is between about 2 feet and about 20 feet above the railroad track and the initial position is between about 0 feet and about 5 feet above the railroad track.

4. (canceled)

5. The method of claim 1, wherein the centerline of the portion of the railroad track includes one or more curved portions, one or more substantially straight portions, or a combination of both.

6. The method of claim 1, further comprising determining, using a GPS sensor configured to receive GPS signals, a current location of the aerial vehicle.

7. The method of claim 6, further comprising estimating, using an inertial sensor coupled to the aerial vehicle, the current location of the aerial vehicle based on a previously determined location of the aerial vehicle obtained using the GPS sensor, wherein the inertial sensor includes one or more accelerometers, one or more gyroscopes, or a combination of both.

8. (canceled)

9. The method of claim 7, further comprising comparing the determined or estimated current location of the aerial vehicle to a predetermined destination to determine whether the aerial vehicle has reached the predetermined destination.

10. The method of claim 9, further comprising, responsive to determining that the aerial vehicle has reached the predetermined destination, obtaining, using at least one of the one or more cameras coupled to the aerial vehicle, destination image data reproducible as an image of a portion of the railroad track at the predetermined destination, adjacent to the predetermined destination, or both.

11. The method of claim 10, further comprising transmitting the destination image data to a remote device.

12. The method of claim 1, further comprising:
scanning, using a sensor coupled to the aerial vehicle, for the presence of obstacles along the flight path of the aerial vehicle;
identifying the presence of a first one of the obstacles along the flight path; and
responsive to the identifying, causing the flight path of the aerial vehicle to be adjusted to aid the aerial vehicle in avoiding the identified first obstacle.

13. The method of claim 12, wherein the sensor includes a light detection and ranging (LIDAR) sensor, a simultaneous localization and mapping (SLAM) sensor, or both.

14. The method of claim 12, wherein the causing the flight path of the aerial vehicle to be adjusted includes (i) changing a current altitude of the aerial vehicle relative to the railroad track, (ii) changing a current lateral distance between the aerial vehicle and the centerline of the portion of the railroad track, (iii) or both (i) and (ii).

15. The method of claim 12, wherein the causing the flight path of the aerial vehicle to be adjusted includes inhibiting further movement of the aerial vehicle along the centerline of the railroad track for a predetermined time.

16. The method of claim 12, where the obstacles include vegetation adjacent to the railroad track, fences adjacent to the railroad track, mileposts adjacent to the railroad track, switches of the railroad track, trains traveling along the railroad track or a second adjacent railroad track, vehicles traveling across the railroad track or the second adjacent railroad track, or any combination thereof.

17. The method of claim 12, further comprising obtaining, using the sensor, data reproducible as a three-dimensional model of one or more features of interest along the railroad track.

18. The method of claim 17, wherein the one or more features of interest include rails of the railroad track, cross-ties of the railroad track, switches of the railroad track, mileposts adjacent to the railroad track, vegetation adjacent to the railroad track, fences adjacent to the railroad track, traffic crossings, or any combination thereof.

19. The method of claim 2, wherein the predetermined location is associated with a potential defect in the railroad track.

20-39. (canceled)

40. A system for autonomously navigating an aerial vehicle along a railroad track to a predetermined destination, the system comprising:
one or more cameras configured to generate image data reproducible as an image of a portion of the railroad track; and
a flight controller including a memory device and one or more processors, the one or more processors being configured to:
identify, based at least in part on the image data, a portion of a first rail of the railroad track and a portion of a second rail of the railroad track;
based at least in part on the identified portion of the first rail and the identified portion of the second rail, determine a centerline of the portion of the railroad track; and
generate, based in at least in part on the determined centerline, flight instructions to cause the aerial vehicle to move along relative to the railroad track.

41. The system of claim 40, further comprising a GPS sensor configured to receive GPS signals and (ii) one or more inertial sensors configured to generate motion data indicative of motion of the aerial vehicle, wherein the one or more processors are configured to determine a current location of the aerial vehicle based on GPS signals received by the GPS sensor and estimate a current location of the aerial vehicle based at least in part on motion data from the one or more inertial sensors.

42-53. (canceled)

54. The system of claim 40, wherein the one or more cameras includes a navigation camera and an inspection camera, wherein the navigation camera is aimed at a first portion of the railroad track that is at least partially in front of the aerial vehicle and the inspection camera is aimed a second portion of the railroad track that is generally below the aerial vehicle.

55-56. (canceled)
